(19) United States
(12) Patent Application Publication
(10) Pub. No.: US 2024/0327181 A1
(43) Pub. Date: Oct. 3, 2024

(54) FORKLIFT

(71) Applicant: NAKANISHI METAL WORKS CO., LTD., Osaka (JP)

(72) Inventors: Ryusuke MITSUKAWA, Osaka-shi (JP); Yuichi OTSUJI, Osaka-shi (JP); Hiroshi KATAYAMA, Osaka-shi (JP); Yosuke HASHIMOTO, Osaka-shi (JP)

(73) Assignee: NAKANISHI METAL WORKS CO., LTD., Osaka (JP)

(21) Appl. No.: 18/612,857

(22) Filed: Mar. 21, 2024

(30) Foreign Application Priority Data
Mar. 31, 2023 (JP) 2023-057224
Feb. 8, 2024 (JP) 2024-017641

(51) Int. Cl. B66F 9/075

(52) U.S. Cl. CPC B66F 9/075

(57) ABSTRACT

A forklift includes a top cover body that covers an upper side of a load placed on a fork included in a load handling device, a side cover body that covers a lateral side of the load, an opening/closing body that opens and closes an opening of the side cover body, and a motion conversion mechanism that opens the opening/closing body. The motion conversion mechanism opens the opening/closing body using a lifting/lowering motion of a lifting/lowering member included in the load handling device. The motion conversion mechanism does not include a drive mechanism including a motor, and opens the opening/closing body using the motion of the load handling device.

### BACKGROUND OF THE INVENTION

### Field of the Invention

The present invention relates to a forklift that performs load handling, and particularly relates to a forklift that is suitable for transporting loads outdoors.

### Description of the Background Art

For a forklift that transports loads outdoors, the loads should be protected from wind and rain during rainy weather or the like. Therefore, during rainy weather or the like, the operator covers a load placed on a pallet, directly with a waterproof cover.

Meanwhile, there is a forklift always equipped with a cover and provided with a shutter that is driven by a drive mechanism that includes a motor and opens and closes an opening of the cover (see, for example, Patent Literature (PTL) 1). In a state where the shutter is opened, work of placing a pallet and a load on a fork at a predetermined location, or work of picking up a pallet and a load with the fork is performed. In a state where the shutter is closed, work of transporting a pallet and a load placed on the fork is performed.

### CITATION LIST

### Patent Literature

[PTL 1] Japanese Patent No. 3830130

### SUMMARY OF THE INVENTION

### Technical Problem

When the operator performs work of covering a load placed on a pallet, directly with a waterproof cover, the operator needs to attach and detach the waterproof cover before and after the pallet is transported. Therefore, the amount of work during rainy weather or the like is increased, which reduces the production capacity of a process. In addition, when an unmanned forklift is used, the unmanned forklift is introduced for the purpose of coping with labor shortages and labor saving in warehouses. Accordingly, attaching and detaching of a waterproof cover by an operator is not supposed.

Meanwhile, a forklift that opens and closes an opening of a cover by driving a shutter with a drive mechanism including a motor as in Patent Literature 1 can be used as an unmanned forklift by automatically opening and closing the shutter. However, the power of the battery of the forklift is consumed by the motor for driving the shutter, and wiring to the motor for supplying power and wiring to a sensor for automatically opening and closing the shutter are needed. This causes problems such as an increase in consumption of the power of the battery of the forklift and complication of power wiring and signal wiring in the forklift.

An object of the present invention is to provide a forklift that can protect a load from wind and rain during rainy weather or the like, without requiring an operator to attach and detach a cover and without opening and closing an opening of the cover with a motor-driven shutter.

### Solution to Problem

A forklift according to a first aspect of the present invention includes: a main body; a load handling device that performs load handling; a movement device that performs traveling operation and turning operation; a top cover body that covers an upper side of a load placed on a fork included in the load handling device; a side cover body that has an opening in a surface thereof in a direction from a proximal end portion toward a distal end portion of the fork, and covers a lateral side of the load; an opening/closing body that opens and closes the opening; and a motion conversion mechanism that opens the opening/closing body. The motion conversion mechanism opens the opening/closing body using one of: a lifting/lowering motion of a lifting/lowering member included in the load handling device; a tilting motion, of an outer mast supporting the lifting/lowering member, by a tilt cylinder included in the load handling device; and front-back movement of the outer mast included in the load handling device.

A forklift according to a second aspect of the present invention is the forklift according to the first aspect, in which the motion conversion mechanism opens the opening/closing body using the lifting/lowering motion of the lifting/lowering member. The opening/closing body is opened and closed in a middle range of a stroke of the lifting/lowering motion, and a state where the opening/closing body is closed or a state where the opening/closing body is opened is maintained at a position above the middle range and at a position below the middle range.

A forklift according to a third aspect of the present invention is the forklift according to the first aspect, in which the motion conversion mechanism opens the opening/closing body using the lifting/lowering motion of the lifting/lowering member. The opening/closing body is closed at a predetermined height position in a middle of a stroke of the lifting/lowering motion. The opening/closing body is opened as the lifting/lowering member is moved downward from the predetermined height position, and a state where the opening/closing body is opened is maintained when the lifting/lowering member is further moved downward. The opening/closing body is opened as the lifting/lowering member is moved upward from the predetermined height position, and a state where the opening/closing body is opened is maintained when the lifting/lowering member is further moved upward.

A forklift according to a fourth aspect of the present invention is the forklift according to the first aspect, in which the motion conversion mechanism opens the opening/closing body using the front-back movement of the outer mast. As the outer mast moves in a forward direction, the opening/closing body is pulled by a wire or a belt to open the opening/closing body.

A forklift according to a fifth aspect of the present invention is the forklift according to the first aspect, in which the motion conversion mechanism includes a mechanism that increases displacement of a stroke of the lifting/lowering motion or a mechanism that increases displacement of a stroke of the tilting motion.

A forklift according to a sixth aspect of the present invention is the forklift according to the first aspect, further including a biasing unit that biases the opening/closing body in a direction in which the opening/closing body is closed.

A forklift according to a seventh aspect of the present invention is the forklift according to any one of the first aspect, the second aspect, the third aspect, the fifth aspect, and the sixth aspect, in which the motion conversion mechanism opens the opening/closing body using the lifting/lowering motion of the lifting/lowering member. The opening/closing body is a door, the door is provided with at an upper portion thereof a door runner, and the door runner moves along a guide rail. The motion conversion mechanism includes a link mechanism that transmits an operation force by the lifting/lowering motion to the door, and the door is rotated around a vertical axis by the operation force while the door runner is moving along the guide rail.

A forklift according to an eighth aspect of the present invention is the forklift according to the seventh aspect, in which the door is of a double swing type including left and right door bodies. The door runner includes an inner runner body located at an inner end in a right-left direction of each of the door bodies and rotatable around a vertical axis relative to the door body, and an outer runner body located at an outer end in the right-left direction of each of the door bodies and rotatable around a vertical axis relative to the door body. The inner runner body moves along a first guide rail in the right-left direction, and the outer runner body moves along a second guide rail in a front-back direction. The link mechanism includes guide bodies attached to the lifting/lowering member, operation arms that is driven by lifting and lowering of the guide bodies, and slide arms that moves along the second guide rails by the operation arms. Each of the operation arms rotates around a support axis in the right-left direction, each of the operation arms has a first end portion that moves along the guide body, and each of the operation arms has a second end portion that is connected to a runner body that is a first end portion of the slide arm. Each of the slide arms has a second end portion of that is the outer runner body. As the lifting/lowering member is lifted or lowered, the first end portion of the operation arm moves along the guide body, whereby the operation arm rotates around the support axis, and the second end portion of the operation arm moves the slide arm in a backward direction along the second guide rail, thereby opening the door body.

A forklift according to a ninth aspect of the present invention is the forklift according to the eighth aspect, in which a center of gravity of the operation arm is located in a forward direction with respect to the support axis, and a moment that tilts the operation arm forward around the support axis is applied by a dead weight of the operation arm.

A forklift according to a tenth aspect of the present invention is the forklift according to the eighth aspect, wherein a distance from the support axis to the second end portion of the operation arm is larger than a distance from the support axis to the first end portion of the operation arm.

A forklift according to an eleventh aspect of the present invention is the forklift according to the eighth aspect, in which each of the guide bodies includes an inclined portion which is inclined forward and upward, and the first end portion of each of the operation arms moves along the inclined portion. The operation arm includes a lower arm portion extending in a forward direction from the first end portion and an upper arm portion extending upward from a front end of the lower arm portion in a state where the door bodies are closed. As the lifting/lowering member is lowered, the first end portion of the operation arm moves along the inclined portion of the guide body, whereby the operation arm rotates around the support axis, and the second end portion of the operation arm and the slide arm move in the backward direction, thereby opening the door body.

A forklift according to a twelfth aspect of the present invention is the forklift according to the eleventh aspect, in which each of the guide bodies includes a vertical portion extending vertically upward from an upper end of the inclined portion, and in a state where the first end portion of the operation arm is moving along the vertical portion, the operation arm does not rotate around the support axis.

A forklift according to a thirteenth aspect of the present invention is the forklift according to any one of the first aspect, the second aspect, the third aspect, the fifth aspect, and the sixth aspect, wherein the motion conversion mechanism is a winding transmission device.

A forklift according to a fourteenth aspect of the present invention is the forklift according to the thirteenth aspect, wherein the winding transmission device includes a wire pulled by a lowering motion of the lifting/lowering member and a pulley on which the wire is trained.

The forklift according to the present invention mainly achieves the following effects.
(1) The top cover body that covers the upper side of the load placed on the fork and the side cover body that covers the lateral side of the load are provided, thereby protecting the load from wind and rain during rainy weather or the like.
(2) The opening/closing body that opens and closes the opening of the side cover body is opened by the motion conversion mechanism, thereby eliminating the necessity of the work of attaching and removing a cover by an operator.
(3) The motion conversion mechanism does not include a drive mechanism including a motor, and opens the opening/closing body using the motion of the load handling device, thereby eliminating the consumption of the power of the battery of the forklift by a motor, and eliminating the necessity of wiring, to a motor, for supplying power, etc.

### BRIEF DESCRIPTION OF THE DRAWINGS

FIG. 1 is a perspective view of a forklift according to an embodiment of the present invention, showing a state wherein an opening/closing body is closed;

FIG. 2 is a perspective view of the forklift, showing a state where the opening/closing body is opened;

FIG. 3 is a schematic perspective view of a main part of a motion conversion mechanism for opening the opening/closing body, showing a state where the opening/closing body is closed in a case where the motion conversion mechanism includes a link mechanism for transmitting an operation force by a lifting/lowering motion of lifting/lowering members to the opening/closing body;

FIG. 4 is a schematic perspective view of the main part, showing a state where the opening/closing body is slightly opened;

FIG. 5 is a schematic perspective view of the main part, showing a state where the opening/closing body is opened;

FIG. 6 is a schematic diagram of the main part as viewed from the left side, showing a state where a guide body is located above a first end portion of an operation arm;

FIG. 7 is a schematic diagram of the main part as viewed from the left side, showing a state where the guide body is lowered from the state in FIG. 6 to come into contact with the first end portion of the operation arm;

FIG. 8 is a schematic diagram of the main part as viewed from the left side, showing a state where the guide body is further lowered from the state in FIG. 7 and the first end portion of the operation arm is located at an inclined portion of the guide body;

FIG. 9 is a schematic diagram of the main part as viewed from the left side, showing a state where the guide body is further lowered from the state in FIG. 8 and the first end portion of the operation arm is located at the lower end of a vertical portion of the guide body;

FIG. 10 is a schematic diagram of the main part as viewed from the left side, showing a state where the guide body is further lowered from the state in FIG. 9 and the first end portion of the operation arm is located at the vertical portion of the guide body;

FIG. 11 is a schematic diagram illustrating an example in which the motion conversion mechanism for opening the opening/closing body is a winding transmission device (first modification), as viewed from the left side, showing a state where the opening/closing body is closed;

FIG. 12 is a schematic diagram illustrating the first modification, as viewed from the left side, showing a state where the opening/closing body is opened;

FIG. 13 is a schematic diagram illustrating an example in which the motion conversion mechanism for opening the opening/closing body opens the opening/closing body by both a lifting motion and a lowering motion of the guide body (second modification), as viewed from the left side, showing a state where the opening/closing body is closed;

FIG. 14 is a schematic diagram illustrating the second modification, as viewed from the left side, showing a state where the guide body is lowered and the opening/closing body is opened;

FIG. 15 is a schematic diagram illustrating the second modification, as viewed from the left side, showing a state where the guide body is lifted and the opening/closing body is opened;

FIG. 16 is a schematic diagram illustrating an example in which the motion conversion mechanism is a winding transmission device and a range where the opening/closing body is not opened and closed during a lifting stroke of the lifting/lowering members is provided (third modification), as viewed from the left side, showing a state where a contact plate of a fixed side slide body and a contact plate of a movable side slide body are separated from each other and the opening/closing body is closed;

FIG. 17 is a schematic diagram illustrating the third modification, as viewed from the left side, showing a state at the instant when the lifting/lowering members and the movable side slide body are lowered from the state in FIG. 16 and the contact plate of the movable side slide body comes into contact with the contact plate of the fixed side slide body;

FIG. 18 is a schematic diagram illustrating the third modification, as viewed from the left side, showing a state at the instant when the lifting/lowering members and the movable side slide body are further lowered from the state in FIG. 17, the opening/closing body is opened, and the fixed side slide body is lowered to be abutted and stopped by an abutment stop plate;

FIG. 19 is a schematic diagram illustrating the third modification, as viewed from the left side, showing a state where the lifting/lowering members are further lowered from the state in FIG. 18 while a state where the opening/closing body is opened is maintained;

FIG. 20 is a schematic diagram illustrating an example in which the forklift according to the embodiment of the present invention is a reach forklift (fourth modification), as viewed from the left side, showing a state where the opening/closing body is closed;

FIG. 21 is a schematic plan view with FIG. 20 as a front view;

FIG. 22 is a schematic diagram illustrating the fourth modification, as viewed from the left side, showing a state where a mast and a fork are moved forward and the opening/closing body is opened; and

FIG. 23 is a schematic plan view with FIG. 22 as a front view.

### DESCRIPTION OF THE PREFERRED EMBODIMENTS

Hereinafter, an embodiment according to the present invention will be described with reference to the drawings.

In the following embodiment, a direction in which the distal end side of a fork of a forklift is viewed from the proximal side of the fork is defined as forward (arrow F in the drawings indicates the forward direction), a direction opposite thereto is defined as back (arrow B in the drawings indicates the backward direction), and the left and the right are defined with respect to the forward direction (arrow L in the drawings indicates the leftward direction, and arrow R in the drawings indicates the rightward direction).

A forklift of the present invention includes a cover body for protecting a load placed on a fork from wind and rain, and is an unmanned forklift or a manned forklift. In the following embodiment, an example in which the forklift of the present invention is an unmanned forklift will be described.

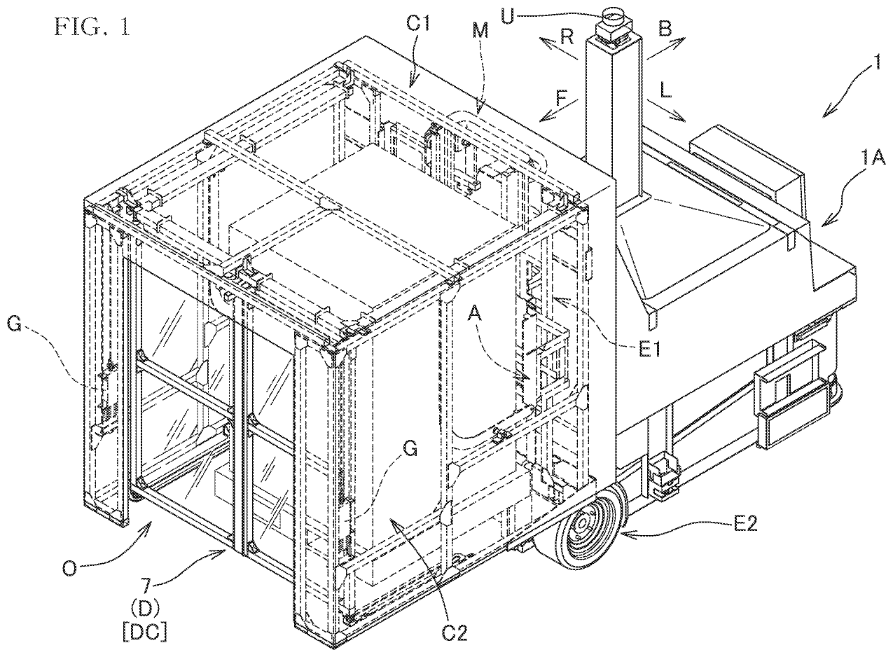

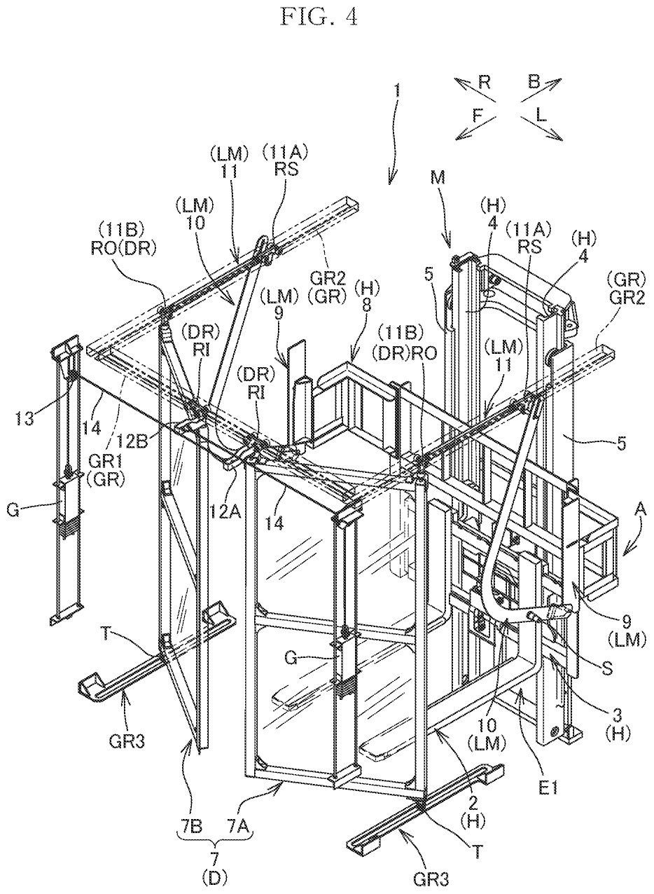

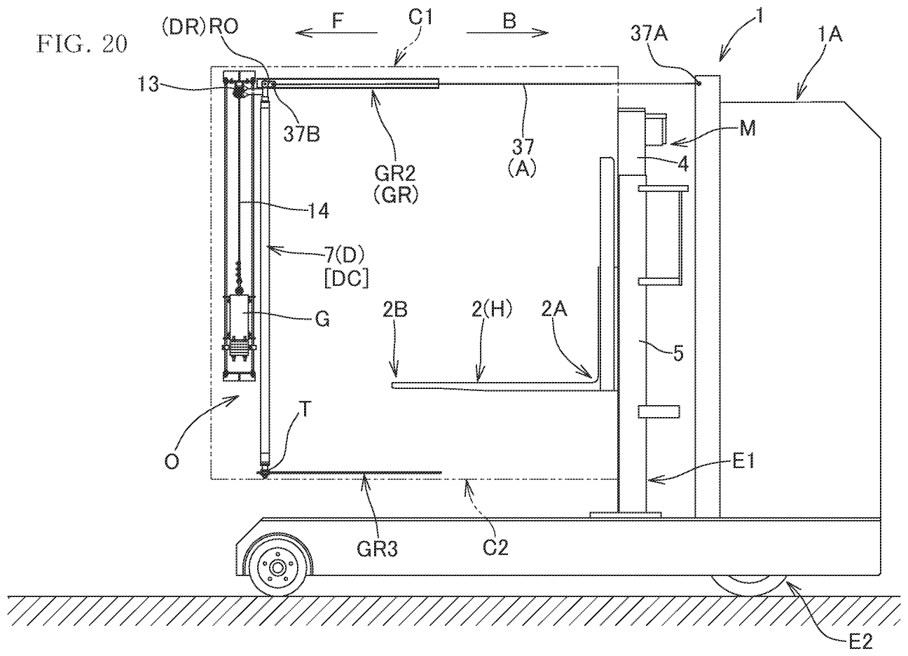

In the following embodiment, FIGS. 1 to 19 illustrate examples in which a forklift 1 according to the embodiment of the present invention is a counterbalanced forklift, and FIGS. 20 to 23 illustrate an example in which the forklift 1 according to the embodiment of the present invention is a reach forklift.

### Forklift

The forklift 1 according to the embodiment of the present invention shown in FIGS. 1 to 5 includes a main body 1A, a load handling device E1, a movement device E2, a controller which is not shown, a top cover body C1, a side cover body C2, an opening/closing body D, a motion conversion mechanism A, and the like. The load handling device E1 performs load handling, and the movement device E2 performs traveling and turning operations.

The controller controls the load handling device E and the movement device E2. The top cover body C1 covers the upper side of a load Q placed on a fork 2. The side cover body C2 covers the lateral side of the load Q, and has an opening O in a surface thereof in a direction from a proximal end portion 2A toward a distal end portion 2B of the fork 2 (forward direction F in the present embodiment). The opening/closing body D opens and closes the opening O, and the motion conversion mechanism A opens the opening/closing body D.

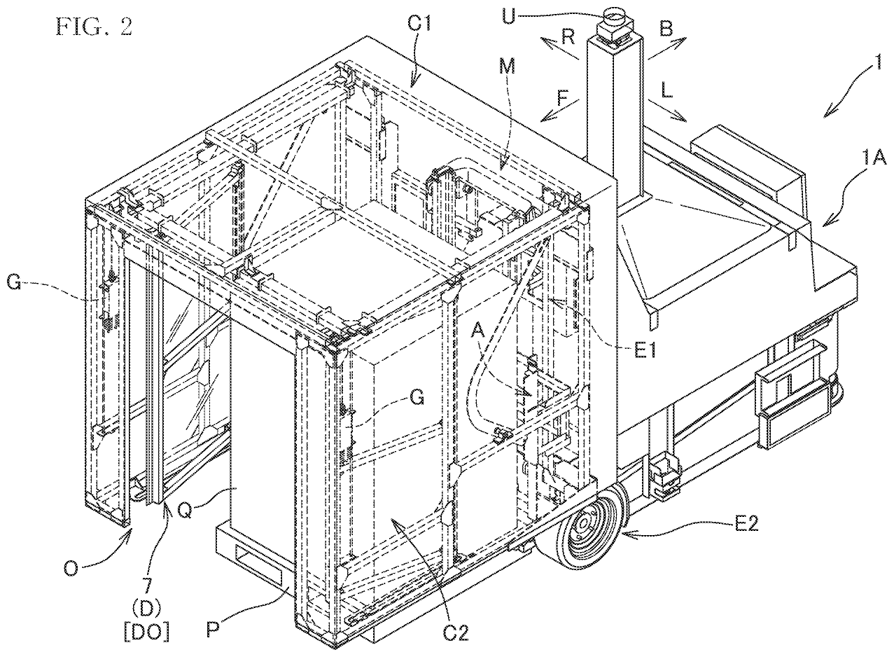

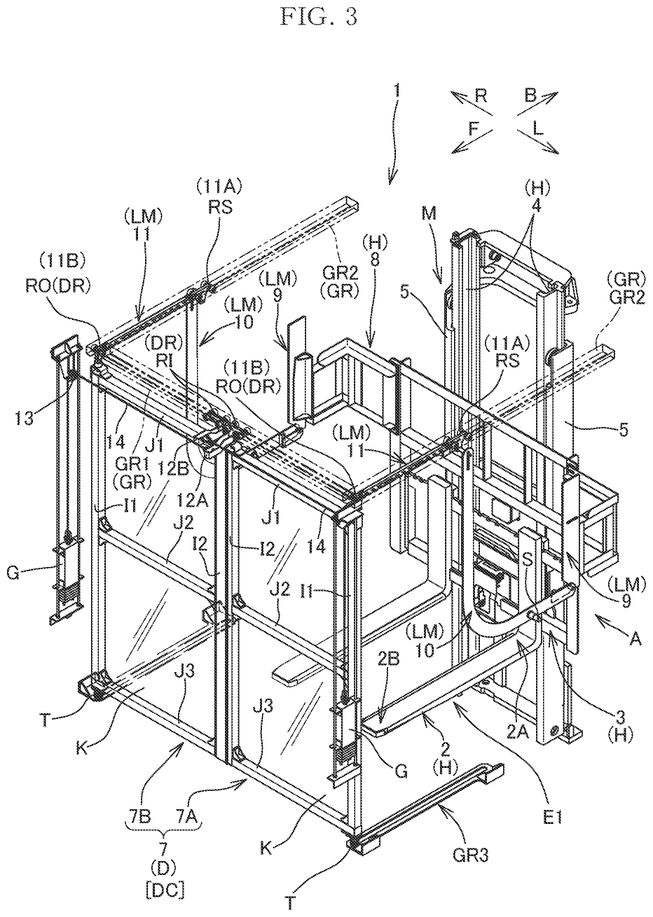

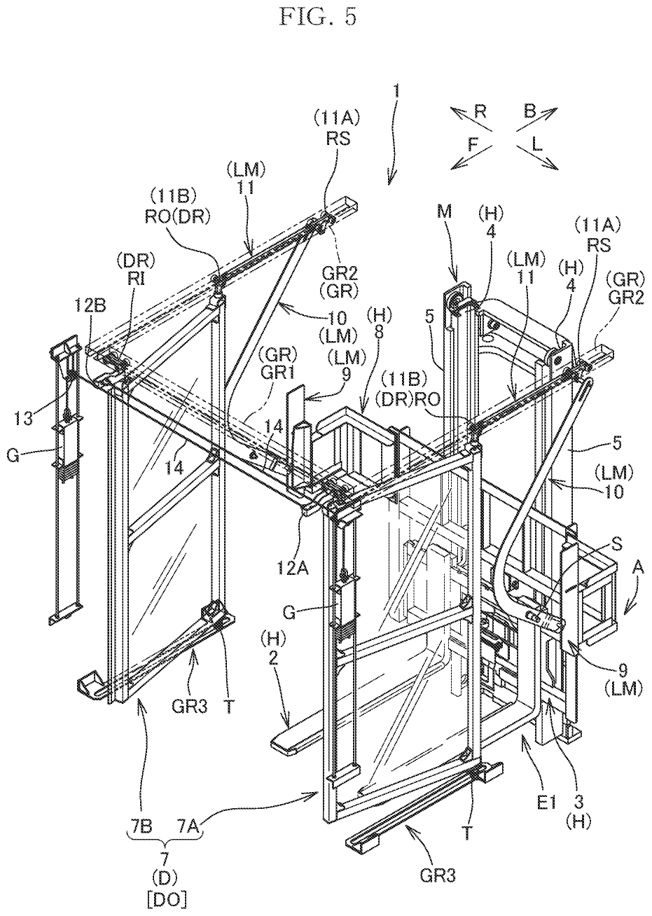

The opening/closing body D is brought into an opened state DO as shown in FIG. 2 and FIG. 5, by the motion conversion mechanism A. The opening/closing body D may not be opened by the motion conversion mechanism A. In such a situation, the opening/closing body D is biased by weights G which are biasing means for biasing the opening/closing body D in a direction in which the opening/closing body D is closed, thereby maintaining a state DC where the opening/closing body D is closed as shown in FIG. 1 and FIG. 3.

The load handling device E1 includes a mast M which is lifted and lowered and is tilted in the front-back direction, the fork 2 on which a pallet P and the load Q shown in FIG. 2 are placed, and a lift bracket 3, shown in FIGS. 3 to 5, which supports the fork 2 and is moved up and down along the mast M.

The fork 2 and the lift bracket 3 are moved up and down along inner masts 4 through lift chains which are not shown. The mast M includes the inner masts 4 which support the lift bracket 3 and are lifted and lowered, and outer masts 5 which guide the inner masts 4 so that the inner masts 4 can be lifted and lowered. Lifting/lowering members H included in the load handling device E1 include the fork 2, the lift bracket 3, the inner masts 4, a support frame body 8 which supports guide bodies 9 described later, and the like. The outer masts 5 are tilted in the front-back direction by a tilt cylinder 6.

The forklift 1 is an unmanned forklift that is self-propelled according to a destination instruction from a management device performing wireless communication with the forklift 1 and performs load handling. The forklift 1 includes a self-position recognition sensor U and has a self-position estimation function. The self-position recognition sensor U is placed on the upper surface of a frame protruding upward from the main body 1A, so as to face upward, and performs 3D imaging in all horizontal directions and a vertical field of view of about 30°, for example. The self-position recognition sensor U is, for example, a three-dimensional light detection and ranging (3D-LiDAR), and is used for a laser simultaneous localization and mapping (SLAM) type self-position estimation method. For the self-position estimation of the forklift 1, an image SLAM type self-position estimation method or the like may be employed.

### Opening/Closing Body

An example in which the opening/closing body D is a door 7 will be described.

As shown in FIGS. 3 to 5, the opening/closing body D is the door 7, and the door 7 is of a double swing type including left and right door bodies 7A and 7B. As shown in FIG. 3, the door bodies 7A and 7B each include an inner vertical frame I1 in the right-left direction, an outer vertical frame 12 in the right-left direction, upper and lower horizontal frames J1, J2, and J3, and a transparent or translucent resin plate K supported by these frames. The door 7 may be of a single swing type. The opening/closing body D may be a sheet body N described later or the like instead of the door 7.

A protruding piece 12A is attached to an inner end in the right-left direction of the horizontal frame J1 of the door body 7A so as to protrude forward, and a protruding piece 12B is attached to an inner end in the right-left direction of the horizontal frame J1 of the door body 7B so as to protrude forward. One end portion of a wire 14 is attached to the protruding piece 12A of the left door body 7A, and the wire 14 is trained on a right pulley 13. Then, the weight G is attached to the other end portion of the wire 14. One end portion of a wire 14 is attached to the protruding piece 12B of the right door body 7B, and the wire 14 is trained on a left pulley 13 which is not shown. Then, a weight G is attached to the other end portion of the wire 14. The left and right door bodies 7A and 7B are biased by the weights G in a direction in which the door bodies 7A and 7B are closed.

### Motion Conversion Mechanism

### (Using a Lifting/Lowering Motion of the Lifting/Lowering Members)

An example will be described in which the motion conversion mechanism A includes link mechanism LM for transmitting an operation force by a lifting/lowering motion of the lifting/lowering members H to the opening/closing body D. In the case where the motion conversion mechanism A opens the opening/closing body D using the lifting/lowering motion of the lifting/lowering members H, a frame that supports the cover bodies C1 and C2 is attached to the outer masts 5.

As shown in FIGS. 3 to 5, there is a door runner DR at an upper portion of the door 7 that is the opening/closing body D. The door runner DR moves along a guide rail GR. The motion conversion mechanism A includes the link mechanism LM for transmitting an operation force by the lifting/lowering motion of the lifting/lowering members H to the door 7, and the door 7 is rotated around a vertical axis by the operation force while the door runner DR is moving along the guide rail GR.

As shown in FIG. 3, the door runner DR includes inner runner bodies RI which are located at the inner ends in the right-left direction of the horizontal frames J1 of the door bodies 7A and 7B and are rotatable around vertical axes relative to the door bodies 7A and 7B, and outer runner bodies RO which are located at the outer ends in the right-left direction of the horizontal frames J1 of the door bodies 7A and 7B and are rotatable around vertical axes relative to the door bodies 7A and 7B. Each inner runner body RI moves along a first guide rail GR1 in the right-left direction, and each outer runner body RO moves along a second guide rail GR2 in the front-back direction. Guide rollers T located at the outer ends in the right-left direction of the horizontal frames J3 of the door bodies 7A and 7B move along third guide rails GR3 in the front-back direction.

As shown in FIGS. 3 to 10, the link mechanism LM includes the guide bodies 9 that are attached to the support frame body 8, which is the lifting/lowering member H, operation arms 10 that are driven by lifting and lowering of the guide bodies 9, and slide arms 11 which move along the second guide rails GR2 by the operation arms 10.

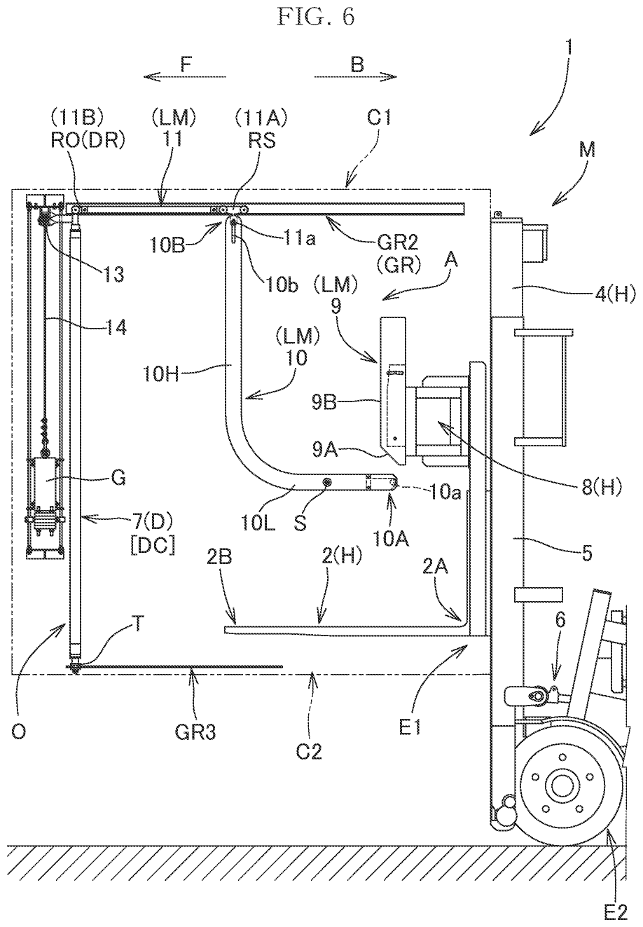

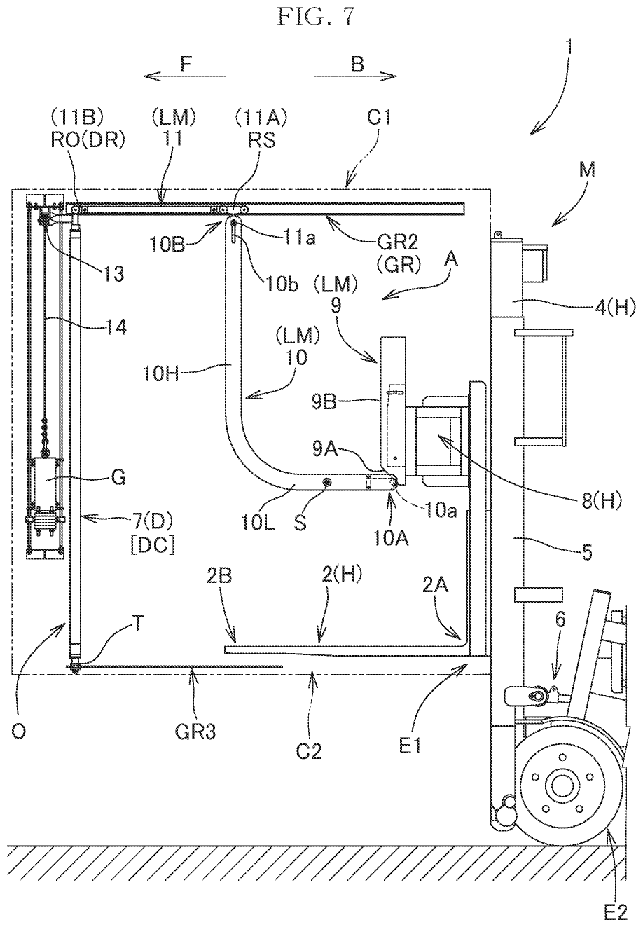

Each operation arm 10 includes a lower arm portion 10L extending in the forward direction F from a first end portion 10A, and an upper arm portion 10H extending upward from the front end of the lower arm portion 10L in the state DC shown in FIG. 6 and FIG. 7 where the door 7 is closed. The operation arm 10 is supported so as to be rotatable around a support axis S in the right-left direction, and the first end portion 10A of the operation arm 10 moves along the guide body 9 which is long in the up-down direction.

The center of gravity of the operation arm 10 is located in the forward direction F with respect to the support axis S, and a moment that tilts the operation arm 10 forward around the support axis S is applied by the dead weight of the operation arm 10. Accordingly, a force in the direction in which the door 7 is closed is applied by the operation arm 10, which can make the weight G smaller. A force is applied to the operation arm 10 in the same direction as the force applied to the slide arm 11 by the weight G in the direction in which the door 7 is closed, so that vibration is restrained.

The distance from the support axis S to a second end portion 10B of the operation arm 10 is larger than the distance from the support axis S to the first end portion 10A of the operation arm 10. Accordingly, the displacement of the slide arm 11 in the front-back direction is increased relative to the displacement of the lifting/lowering members H in the up-down direction. Therefore, even if the lifting stroke of the lifting/lowering members H is small, the stroke for opening the door 7 becomes large.

As shown in FIG. 6, in a state where the guide body 9 is not in contact with the operation arm 10, the state DC where the door 7 is closed is maintained by the weight G, which is the biasing unit, and the moment caused by the dead weight of the operation arm 10.

The guide body 9 includes an inclined portion 9A inclined forward and upward and a vertical portion 9B extending upward from an upper end portion of the inclined portion 9A, for example, as shown in FIG. 6. The operation arm 10 is rotated around the support axis S by the guide body 9 pressing a pin 10a in the right-left direction, which is located at the first end portion 10A of the operation arm 10, as shown in FIGS. 7 to 9.

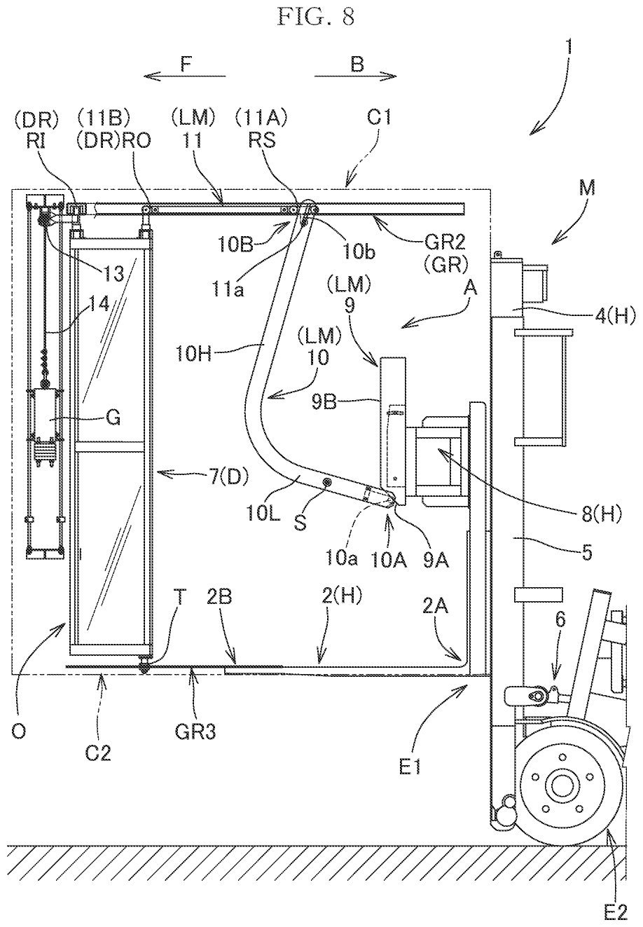

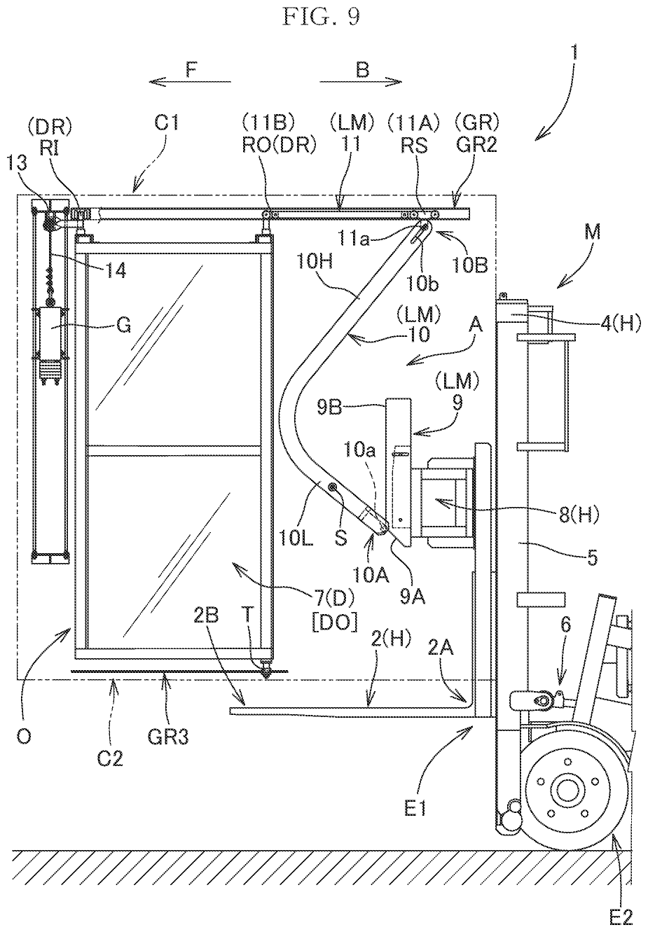

That is, when the guide body 9 is lowered together with the lifting/lowering members H and the pin 10a is moved along the inclined portion 9A, the second end portion 10B, which is an upper end portion of the operation arm 10, moves in the backward direction B (FIG. 7→FIG. 8→FIG. 9). When the guide body 9 is lifted together with the lifting/lowering members H from the state in FIG. 9 and the pin 10a is moved along the inclined portion 9A, the second end portion 10B, which is the upper end portion of the operation arm 10, moves in the forward direction F (FIG. 9→FIG. 8→FIG. 7).

The second end portion 10B of the operation arm 10 is connected to a runner body RS which is a first end portion 11A at the back of the slide arm 11. That is, a pin 11a in the right-left direction, which is located below the runner body RS, is inserted into a long hole 10b of the second end portion 10B of the operation arm 10. A second end portion 11B at the front of the slide arm 11 is the outer runner body RO.

When the guide body 9 is lowered as the support frame body 8, which is the lifting/lowering member H, is lowered from a state where the guide body 9 is located above the first end portion 10A of the operation arm 10 as shown in FIG. 6, the inclined portion 9A of the guide body 9 comes into contact with the pin 10a of the operation arm 10 as shown in FIG. 7. In the range from FIG. 6 to FIG. 7, the operation arm 10 remains stationary, and the state DC where the door 7, which is the opening/closing body D, is closed is maintained.

When the guide body 9 is further lowered from the state in FIG. 7 as shown in FIG. 8, the pin 10a located at the first end portion 10A of the operation arm 10 moves along the inclined portion 9A, and the operation arm 10 rotates around the support axis S. Accordingly, the second end portion 10B of the operation arm 10 moves in the backward direction B, and the slide arm 11 and the outer runner body RO also move in the backward direction B, so that the door 7 opens while rotating around the vertical axis.

When the guide body 9 is further lowered from the state in FIG. 8, as shown in FIG. 9, the pin 10a located at the first end portion 10A of the operation arm 10 moves along the inclined portion 9A to the upper end portion of the inclined portion 9A, and the operation arm 10 further rotates around the support axis S. Accordingly, the second end portion 10B of the operation arm 10 further moves in the backward direction B, and the slide arm 11 and the outer runner body RO also further move in the backward direction B, so that the state DO where the door 7 is opened is achieved.

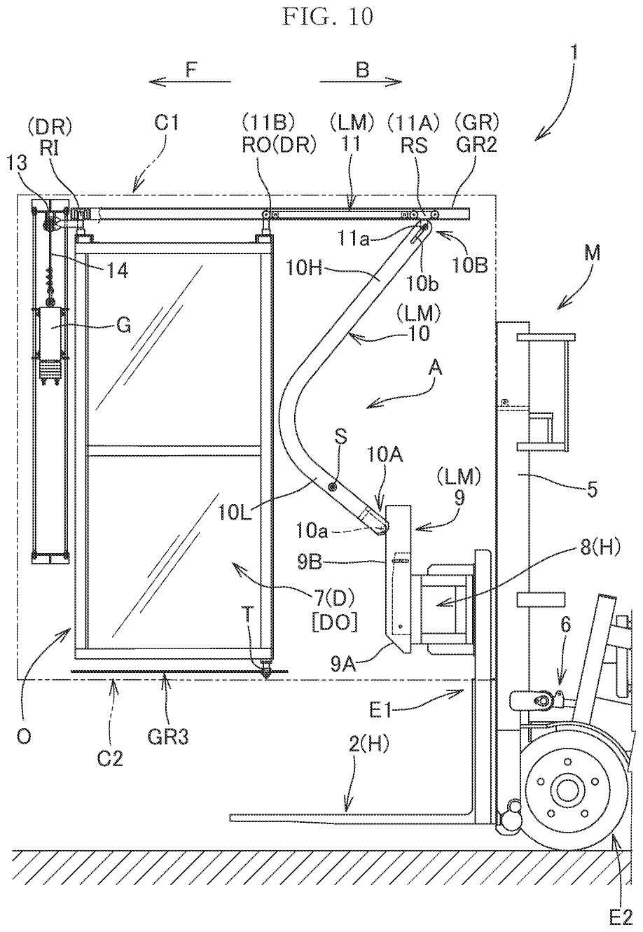

When the guide body 9 is further lowered from the state in FIG. 9, as shown in FIG. 10, the pin 10a located at the first end portion 10A of the operation arm 10 moves along the vertical portion 9B of the guide body 9. In the range from FIG. 9 to FIG. 10, the operation arm 10 remains stationary without rotating around the support axis S, and the state DO where the door 7, which is the opening/closing body D, is opened is maintained.

Owing to such a configuration, the opening/closing body D can be opened and closed in a middle range (FIGS. 7 to 9) of the stroke of the lifting/lowering motion of the lifting/lowering members H. In a range (FIGS. 6 and 7) where the lifting/lowering members H are located above the middle range, the state DC where the opening/closing body D is closed is maintained, and in a range (FIGS. 9 and 10) where the lifting/lowering members H are located below the middle range, the state DO where the opening/closing body D is opened is maintained.

When the forklift 1 moves to a predetermined position away from a position where load handling is performed, the lifting/lowering members H are caused to be at a high position to bring the opening/closing body D into the closed state DC as shown in FIG. 6, for example. When the forklift 1 moves from the predetermined position to the position where load handling is performed, the lifting/lowering members H are lowered in advance to bring the opening/closing body D into the opened state DO as shown in FIG. 9, for example. When the forklift 1 performs load handling, the load handling is performed with the lifting/lowering members H being caused to be at a lower position (e.g., in the range in FIGS. 9 and 10) while the state DO where the opening/closing body D is opened is maintained. Since the state DO where the opening/closing body D is opened is ensured and load handling can be performed while this state is maintained, interference between the opening/closing body D and other members can be avoided.

### Using Tilting Motions of the Outer Masts

The motion conversion mechanism A in the above description includes the link mechanism LM for transmitting an operation force by the lifting/lowering motion of the lifting/lowering members H included in the load handling device E1 to the opening/closing body D, but the motion conversion mechanism A may include a link mechanism for transmitting an operation force by tilting motions of the outer masts 5 by the tilt cylinder 6 included in the load handling device E1 to the opening/closing body D. In the case where the motion conversion mechanism A opens the opening/closing body D using the tilting motions of the outer masts 5, the frame that supports the cover bodies C1 and C2 is attached to the main body 1A.

In such a case, for example, protruding members protruding in the forward direction F from the outer masts 5 are used. At a normal position where the outer masts 5 are substantially vertical, each protruding member presses the first end portion 10A of the operation arm 10 in the forward direction F to rotate the operation arm 10 around the support axis S and move the second end portion 10B of the operation arm 10 in the backward direction B, thereby bringing the opening/closing body D into the opened state DO. At the backward tilted position of each outer mast 5, the protruding member is disengaged from the operation arm 10, so that the opening/closing body D is brought into the closed state DC by the biasing force of the weight G, etc.

### First Modification

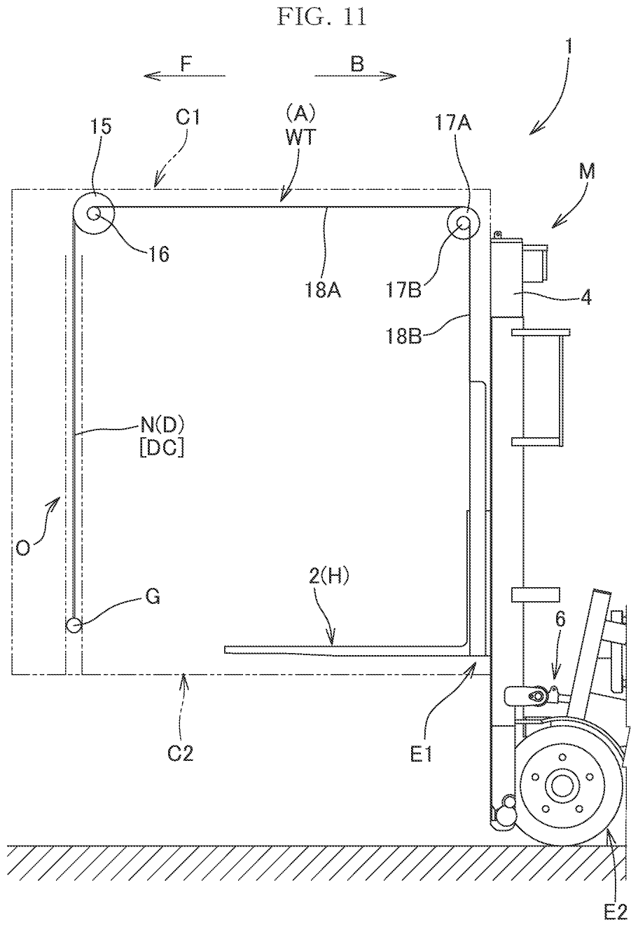

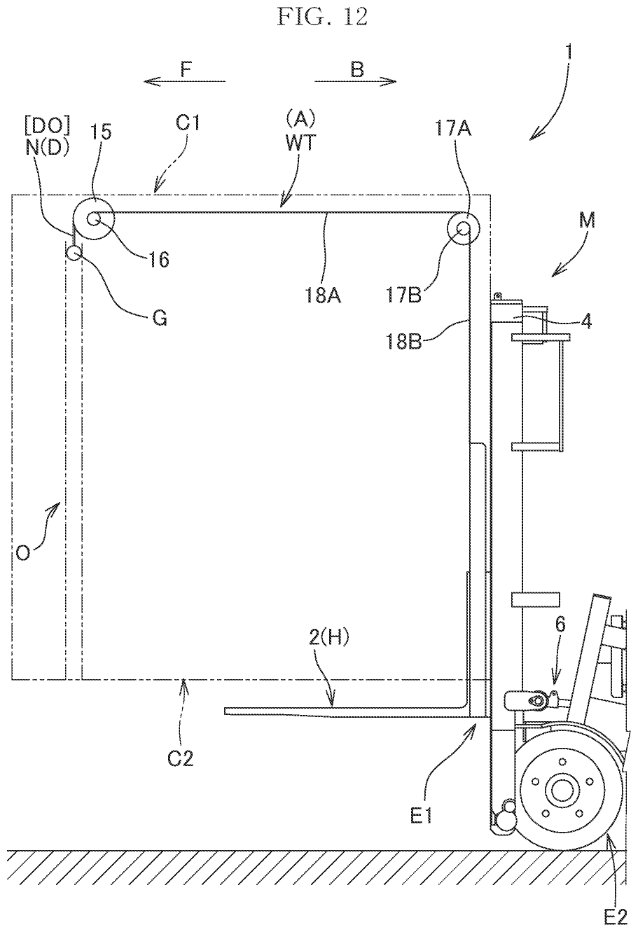

The forklift 1 shown in FIGS. 11 and 12 illustrates an example in which the motion conversion mechanism A is a winding transmission device WT. In this example, the opening/closing body D is, for example, the sheet body N.

A lower end portion of the sheet body N is attached to a weight G, and an upper end portion of the sheet body N is attached to a roller 15. When the roller 15 rotates in a clockwise direction as viewed from the left side, the sheet body N is wound onto the roller 15. When the roller 15 rotates in a counterclockwise direction as viewed from the left side, the sheet body N is unwound from the roller 15.

A pulley 16 having a smaller diameter than the roller 15 is coaxially attached to the roller 15, and a large-diameter pulley 17A is placed closer to the mast M in the backward direction B than the pulley 16 is. A wire 18A is wound around the pulley 16, one end portion of the wire 18A is attached to the pulley 16, the wire 18A is wound around the large-diameter pulley 17A, and the other end portion of the wire 18A is attached to the large-diameter pulley 17A.

A small-diameter pulley 17B is coaxially attached to the large-diameter pulley 17A. A wire 18B is wound around the small-diameter pulley 17B, and one end portion of the wire 18B is attached to the small-diameter pulley 17B. The wire 18B is hung from the small-diameter pulley 17B, and the other end portion of the wire 18B is attached to the lifting/lowering member H such as the fork 2, for example.

When the lifting/lowering member H is lowered as shown in FIG. 12 from a state where the sheet body N is unwound from the roller 15 and covers the opening O as shown in FIG. 11 (the state DC where the opening/closing body D is closed), the small-diameter pulley 17B and the large-diameter pulley 17A rotate as the wire 18B is lowered, the wire 18A moves in the backward direction B, and the pulley 16 and the roller 15 rotate. Accordingly, the sheet body N is wound onto the roller 15, so that the state DO where the opening/closing body D is opened is achieved. Load handling can be performed in a certain range where the lifting/lowering member H is located on the lower side.

When the lifting/lowering member H is lifted from the state DO in FIG. 12 where the opening/closing body D is opened, the opening/closing body D is biased by the weight G, which is a biasing unit, in the direction in which the opening/closing body D is closed. Accordingly, the sheet body N is hung from the roller 15, and the state DC shown in FIG. 11 where the opening/closing body D is closed is achieved.

In such a motion conversion mechanism A, the displacement of the sheet body N and the weight G in the up-down direction is increased relative to the displacement of the lifting/lowering member H in the up-down direction by the small-diameter pulley 17B and the large-diameter pulley 17A, which are coaxial, and the pulley 16 and the large-diameter roller 15, which are coaxial. Therefore, the lifting stroke of the sheet body N which is the opening/closing body D can be increased.

If the motion conversion mechanism A is configured with the winding transmission device WT, the direction of force is easily changed, no backlash is caused, and the space for the motion conversion mechanism A is saved and the weight of the motion conversion mechanism A is reduced as compared to the motion conversion mechanism A configured with the link mechanism LM. In addition, when the motion conversion mechanism A is configured with the winding transmission device WT, the lifting stroke of the sheet body N can be easily adjusted by changing the diameters of the rollers and the pulleys.

### Second Modification

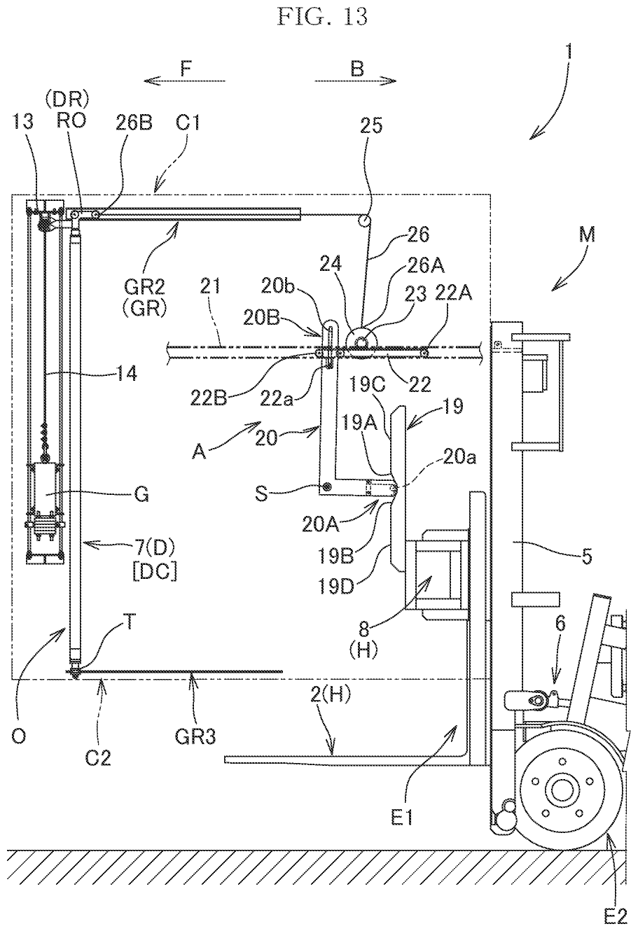

The forklift 1 shown in FIGS. 13 to 15 illustrates an example in which the motion conversion mechanism A opens the opening/closing body D by both a lowering motion and a lifting motion of each guide body 19. In this example, the opening/closing body D is, for example, the door 7.

In FIG. 13, an operation arm 20 is supported so as to be rotatable around a support axis S in the right-left direction, a pin 20a in the right-left direction is provided at a first end portion 20A in the backward direction B with respect to the support axis S, and a long hole 20b in the up-down direction is formed in a second end portion 20B above the support axis S.

Wheel bodies 22A and 22B are attached to a rack 22, and the rack 22 is movable in the front-back direction along a support frame 21. A pin 22a in the right-left direction provided to the wheel body 22B is inserted into the long hole 20b of the operation arm 20. A pinion 23 engages the rack 22. The pinion 23 and a roller 24 are coaxial and supported so as to be rotatable around a support axis in the right-left direction. A first end portion 26A of a wire 26 that is trained on a pulley 25 and extends downward is attached to the roller 24. A second end portion 26B of the wire 26 extending in the forward direction F from the pulley 25 is attached to the outer runner body RO.

The guide body 19 which is long in the up-down direction is attached to the support frame body 8 which is the lifting/lowering member H, and includes inclined portions 19A and 19B and vertical portions 19C and 19D on a front surface thereof. The inclined portions 19A and 19B are located above and below a center portion in the up-down direction of the front surface of the guide body 19, the inclined portion 19A is inclined forward and upward, and the inclined portion 19B is inclined forward and downward. The vertical portion 19C extends upward from an upper end portion of the inclined portion 19A, and the vertical portion 19D extends downward from a lower end portion of the inclined portion 19B.

The pin 20a of the operation arm 20 moves along the guide body 19. In the state shown in FIG. 13, the pin 20a is located between the upper and lower inclined portions 19A and 19B, and the door 7 that is the opening/closing body D is in the closed state DC.

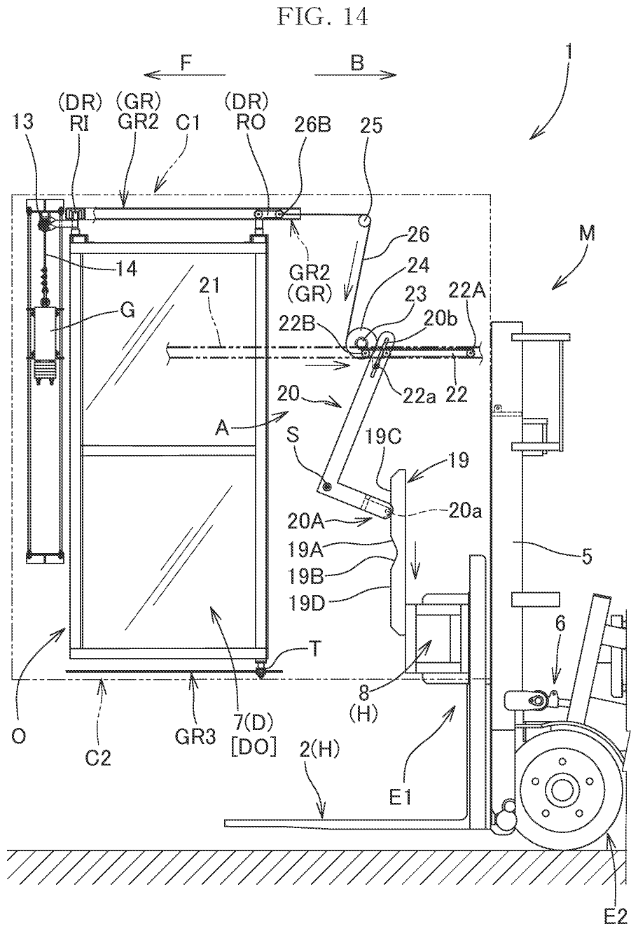

As shown in FIG. 14, when the guide body 19 is lowered together with the lifting/lowering members H, the operation arm 20 rotates while the pin 20a is moving along the inclined portion 19A, and the rack 22 moves in the backward direction B. Accordingly, the pinion 23 rotates, and the roller 24 winds the wire 26 thereon, so that the outer runner body RO is pulled in the backward direction B by the wire 26, and the state DO where the door 7 is opened is achieved. In a state where the pin 20a is moving along the vertical portion 19C of the guide body 19, the state DO where the door 7 is opened is maintained.

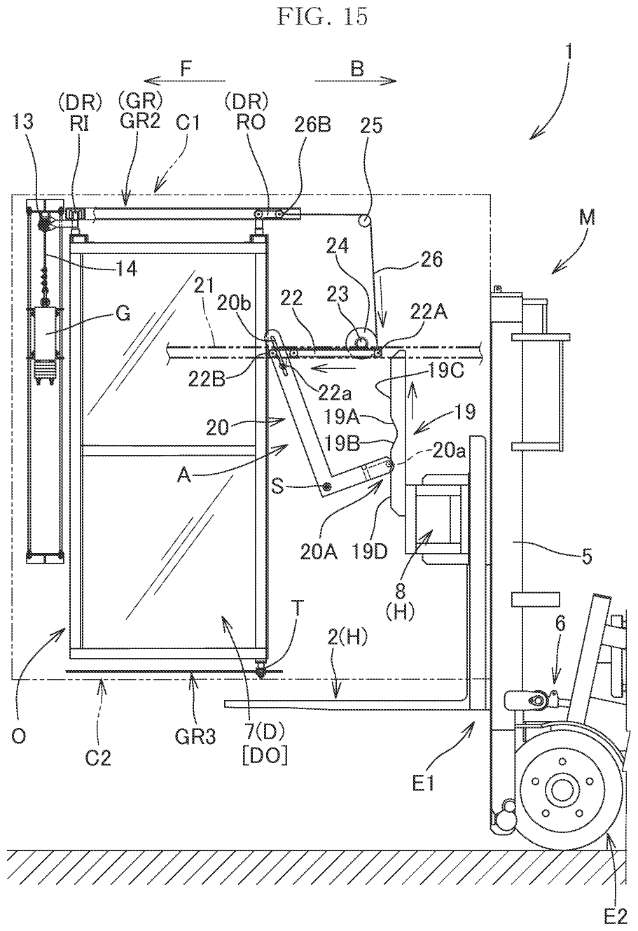

As shown in FIG. 15, when the guide body 19 is lifted together with the lifting/lowering members H, the operation arm 20 rotates while the pin 20a is moving along the inclined portion 19B, and the rack 22 moves in the forward direction F. Accordingly, the pinion 23 rotates, and the roller 24 winds the wire 26 thereon, so that the outer runner body RO is pulled in the backward direction B by the wire 26, and the state DO where the door 7 is opened is achieved. In a state where the pin 20a is moving along the vertical portion 19D of the guide body 19, the state DO where the door 7 is opened is maintained.

The motion conversion mechanism A of the forklift 1 shown in FIGS. 13 to 15 opens the opening/closing body D using the lifting/lowering motion of the lifting/lowering members H. At a predetermined height position in the middle of the stroke of the lifting/lowering motion of the lifting/lowering members H (FIG. 13), the opening/closing body D is in the closed state DC.

As the lifting/lowering members H are moved downward from the predetermined height position, the opening/closing body D is opened first while the pin 20a is moved along the inclined portion 19A. When the lifting/lowering members H are further moved downward, the pin 20a is moved along the vertical portion 19C (FIG. 14), so that the state DO where the opening/closing body D is opened is maintained.

As the lifting/lowering members H are moved upward from the predetermined height position, the opening/closing body D is opened first while the pin 20a is moved along the inclined portion 19B. When the lifting/lowering members H are further moved upward, the pin 20a is moved along the vertical portion 19D (FIG. 15), so that the state DO where the opening/closing body D is opened is maintained.

In such a motion conversion mechanism A, the height of the lifting/lowering members H for closing the opening/closing body D can be set to any height by changing the predetermined height position in the middle of the stroke of the lifting/lowering motion of the lifting/lowering members H, i.e., the heights at which the inclined portions 19A and 19B are provided in the guide body 19. Then, the load Q is transported in a state where the opening/closing body D is closed. For example, when the forklift 1 moves to a predetermined position away from a position where load handling is performed, the opening/closing body D is brought into the closed state DC as shown in FIG. 13.

If the position where the forklift 1 performs load handling is low, when the forklift 1 moves from the predetermined position to the position where load handling is performed, the lifting/lowering members H are lowered in advance to bring the opening/closing body D into the opened state DO as shown in FIG. 14, for example. When the forklift 1 performs load handling, the load handling is performed while the state DO where the opening/closing body D is opened is maintained with the pin 20a being kept along the vertical portion 19C as shown in FIG. 14. Since the state DO where the opening/closing body D is opened is ensured and load handling can be performed while this state is maintained, interference between the opening/closing body D and other members can be avoided.

The position where the forklift 1 performs load handling may be, for example, on the cargo bed of a truck and may be high. In such a case, when the forklift 1 moves from the predetermined position to the position where load handling is performed, the lifting/lowering members H are lifted in advance to bring the opening/closing body D into the opened state DO as shown in FIG. 15, for example. When the forklift 1 performs load handling, the load handling is performed while the state DO where the opening/closing body D is opened is maintained with the pin 20a being kept along the vertical portion 19D as shown in FIG. 15. Since the state DO where the opening/closing body D is opened is ensured and load handling can be performed while this state is maintained, interference between the opening/closing body D and other members can be avoided.

### Third Modification

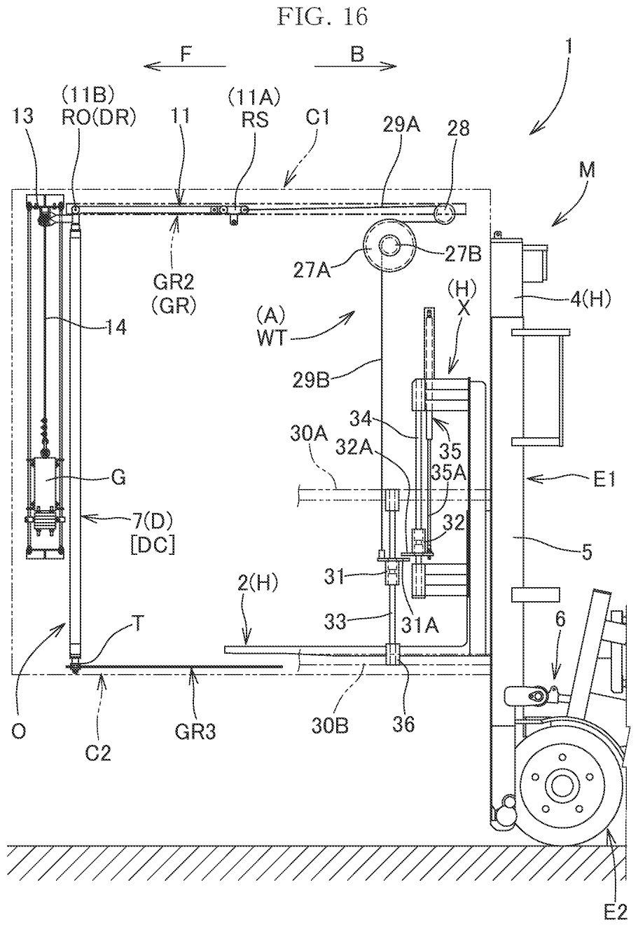

FIGS. 16 to 19 illustrate an example in which the motion conversion mechanism A is the winding transmission device WT and a range where the opening/closing body D is not opened and closed during the lifting stroke of the lifting/lowering members H is provided. In this example, the opening/closing body D is, for example, the door 7.

One end portion of a wire 29A is attached to the runner body RS which is the first end portion 11A at the back of the slide arm 11. The wire 29A is trained on a pulley 28 which is placed closer to the mast M in the backward direction B than the runner body RS is, is drawn in the forward direction F, and is wound around a large-diameter pulley 27A, and the other end portion of the wire 29A is attached to the large-diameter pulley 27A.

A small-diameter pulley 27B is coaxially attached to the large-diameter pulley 27A. A wire 29B is wound around the small-diameter pulley 27B, and one end portion of the wire 29B is attached to the small-diameter pulley 27B. The wire 29B is hung from the small-diameter pulley 27B, and the other end portion of the wire 29B is attached to a fixed side slide body 31. The fixed side slide body 31 includes a contact plate 31A at an upper end portion thereof, and is slidable in the up-down direction relative to a fixed side pillar 33 in the up-down direction. The fixed side pillar 33 is attached to support frames 30A and 30B which are attached to the frame that supports the cover bodies C1 and C2. There is an abutment stop plate 36 at a lower end portion of the fixed side pillar 33.

A movable side slide body 32 is located above the fixed side slide body 31, includes a contact plate 32A at a lower end portion thereof, and is slidable in the up-down direction relative to a movable side pillar 34 in the up-down direction. The movable side pillar 34 is attached to a frame body X which is a lifting/lowering member H. A main body of a gas spring 35 in the up-down direction is attached to the frame body X, and a distal end portion of a piston rod 35A of the gas spring 35 is attached to the movable side slide body 32.

In a state shown in FIG. 16 where the contact plate 31A of the fixed side slide body 31 and the contact plate 32A of the movable side slide body 32 are separated from each other, the door 7 that is the opening/closing body D is biased by the weight G that is the biasing means for biasing the door 7 in the direction in which the door 7 is closed. Accordingly, the state DC where the door 7 is closed is maintained.

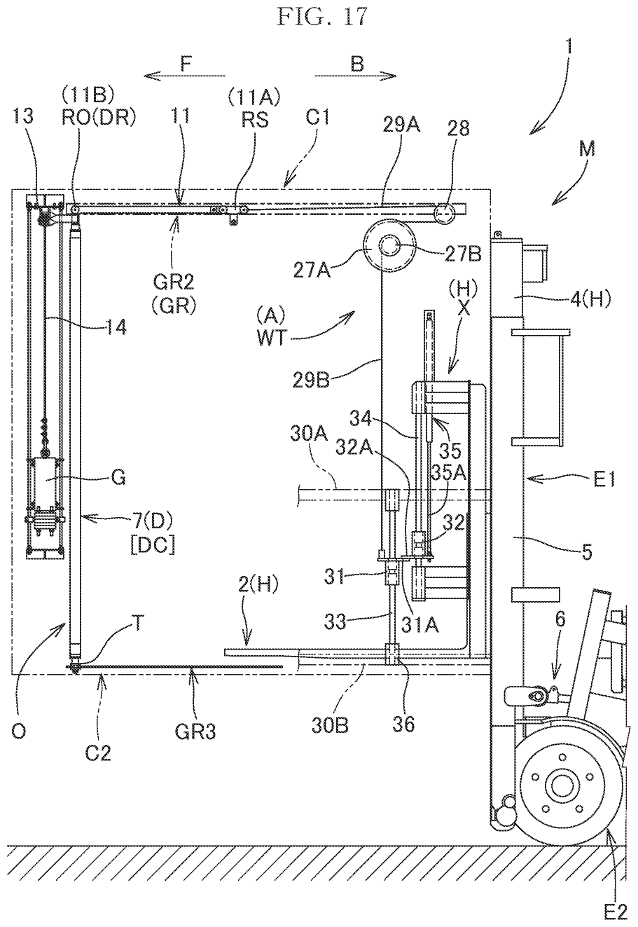

When the lifting/lowering members H and the movable side slide body 32 are lowered from the state where the contact plate 31A of the fixed side slide body 31 and the contact plate 32A of the movable side slide body 32 are separated from each other as shown in FIG. 16, the contact plate 32A of the movable side slide body 32 comes into contact with the contact plate 31A of the fixed side slide body 31 as shown in FIG. 17. In the state in FIG. 17, the door 7 remains in the closed state DC.

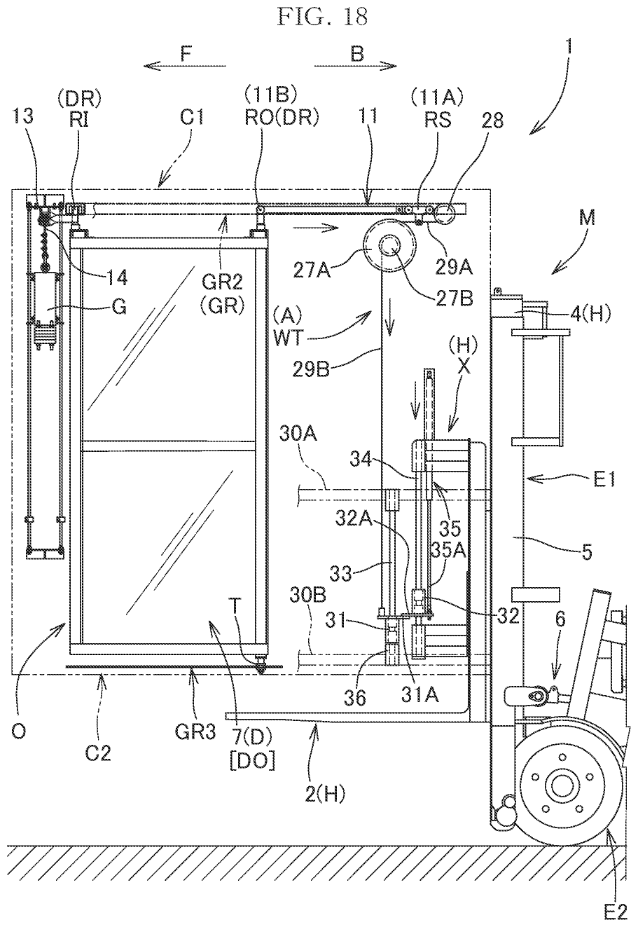

When the lifting/lowering members H and the movable side slide body 32 are further lowered from the state in FIG. 17 as shown in FIG. 18, the contact plate 31A of the fixed side slide body 31 is pressed by the contact plate 32A of the lowered movable side slide body 32, and the fixed side slide body 31 is lowered along the fixed side pillar 33. Accordingly, the wire 29B is pulled, the small-diameter pulley 27B rotates, and the wire 29A is pulled, so that the slide arm 11 and the outer runner body RO move in the backward direction B, and the state DO where the door 7 is opened is achieved.

In the state in FIG. 18, the lower surface of the fixed side slide body 31 is abutted and stopped by the abutment stop plate 36, so that the fixed side slide body 31 cannot be lowered any further. In addition, since the contact plate 32A of the movable side slide body 32 is in contact with the contact plate 31A of the fixed side slide body 31, the movable side slide body 32 also cannot be lowered any further.

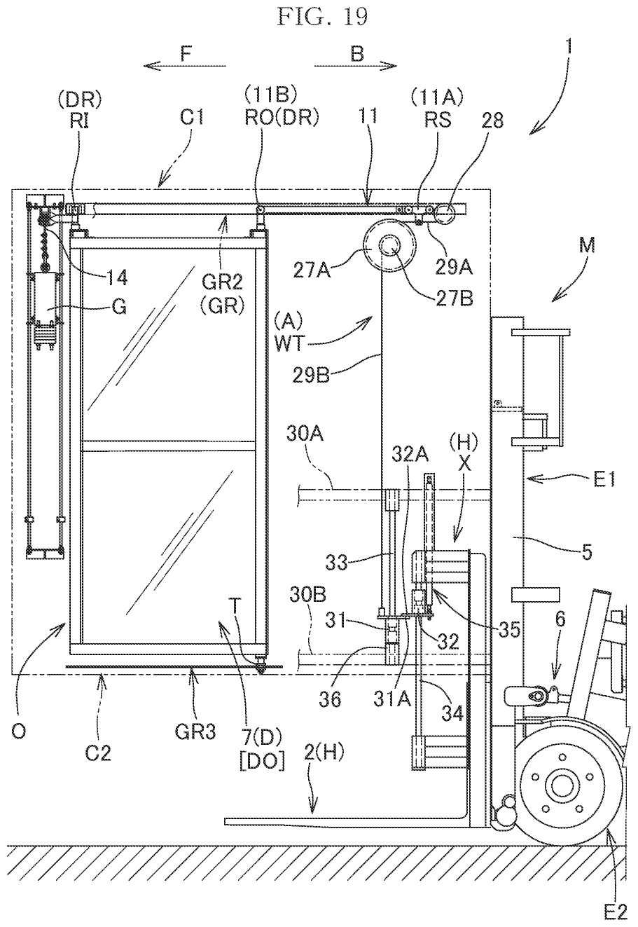

When the lifting/lowering members H are further lowered from the state in FIG. 18, the piston rod 35A retracts so as to be housed in a pressure tube against the biasing force of the gas spring 35, while the state DO where the door 7 is opened is maintained, to thereby achieve a state shown in FIG. 19. While the piston rod 35A of the gas spring 35 is retracting, an upward force acts on the gas spring 35. Accordingly, even if the lifting/lowering members H such as the fork 2 are continuously lowered, a state where the position of the movable side slide body 32 in the height direction is fixed is maintained, and the position of the fixed side slide body 31 in the height direction is also maintained.

Owing to such a configuration, the opening/closing body D can be opened and closed in a middle range (FIGS. 17 and 18) of the stroke of the lifting/lowering motion of the lifting/lowering members H. In a range (FIGS. 16 and 17) where the lifting/lowering members H are located above the middle range, the state DC where the opening/closing body D is closed is maintained, and in a range (FIGS. 18 and 19) where the lifting/lowering members H are located below the middle range, the state DO where the opening/closing body D is opened is maintained.

When the forklift 1 moves to a predetermined position away from a position where load handling is performed, the lifting/lowering members H are caused to be at a high position to bring the opening/closing body D into the closed state DC as shown in FIG. 16, for example. When the forklift 1 moves from the predetermined position to the position where load handling is performed, the lifting/lowering members H are lowered in advance to bring the opening/closing body D into the opened state DO as shown in FIG. 18, for example. When the forklift 1 performs load handling, the load handling is performed with the lifting/lowering members H being caused to be at a lower position (e.g., in the range in FIGS. 18 and 19) while the state DO where the opening/closing body D is opened is maintained. Since the state DO where the opening/closing body D is opened is ensured and load handling can be performed while this state is maintained, interference between the opening/closing body D and other members can be avoided.

### Fourth Modification

The forklift 1 according to the embodiment of the present invention shown in FIGS. 20 to 23 is a reach forklift, and the reference characters same as those for the forklift 1 that is the counterbalanced forklift in FIGS. 1 to 19 denote the same or corresponding components or portions. The forklift 1 in FIGS. 20 to 23 which is a reach forklift can move the outer masts 5 in the front-back direction relative to the main body 1A, and thus can move the fork 2 in the forward direction For the backward direction B without operating the movement device E2.

Therefore, in the forklift 1 in FIGS. 20 to 23, the opening/closing body D can be opened and closed using the front-back movement of the outer masts 5 included in the load handling device E1, instead of the lifting/lowering motion of the lifting/lowering members H included in the load handling device E1. That is, the motion conversion mechanism A for opening the opening/closing body D in the forklift 1 opens the opening/closing body D using the front-back movement of the outer masts 5 included in the load handling device E1. In the case where the motion conversion mechanism A opens the opening/closing body D using the front-back movement of the outer masts 5, the frame that supports the cover bodies C1 and C2 is attached to the outer masts 5.

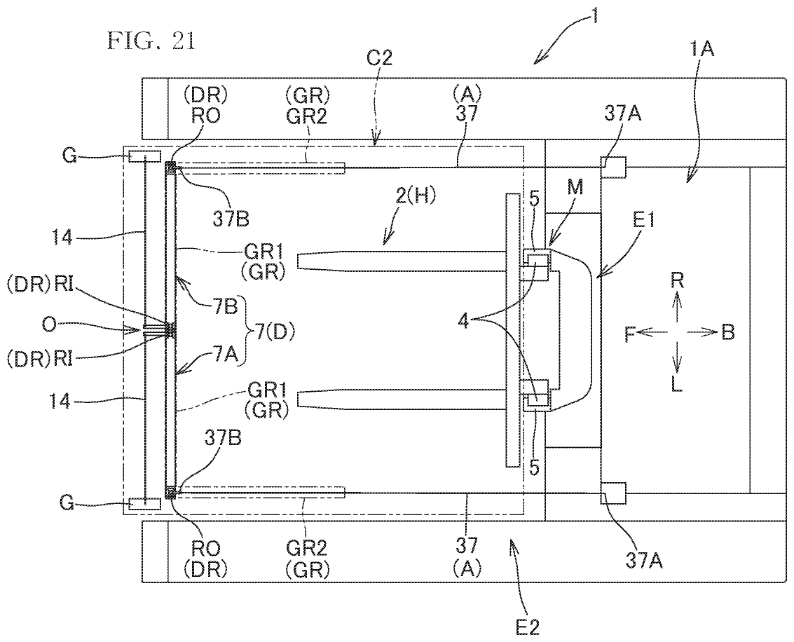

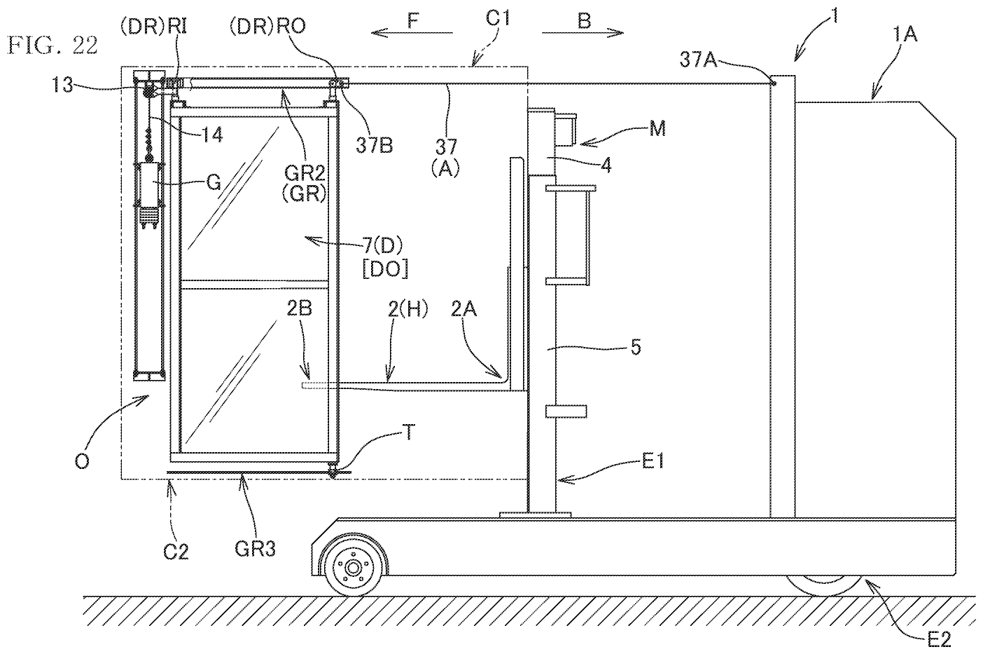

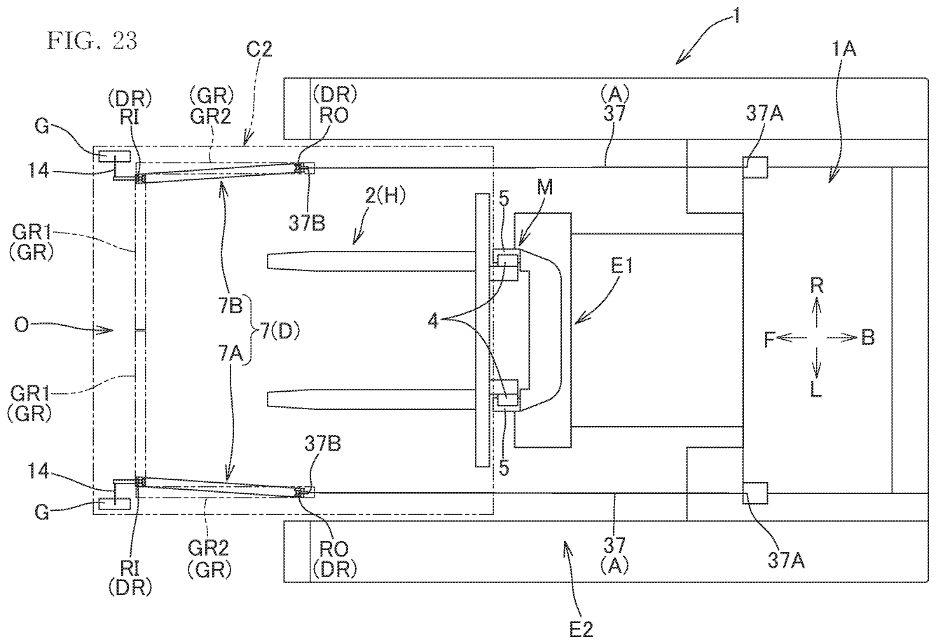

The opening/closing body D is, for example, the door 7. Wires 37 included in the motion conversion mechanism A each have a back end 37A attached to the main body 1A, and a front end 37B attached to the outer runner body RO. In a state shown in FIGS. 20 and 21 where the outer masts 5 are located closest to the main body 1A in the backward direction B, each wire 37 is brought into a substantially straightened state. When the outer masts 5 move in the forward direction F relative to the main body 1A as shown in FIGS. 22 and 23, the front-back position of the outer runner body RO remains unchanged, but the above-described frame moves in the forward direction F. Therefore, as the outer masts 5 move in the forward direction F, the opening/closing body D is pulled along the guide rail GR by each wire 37 (each inner runner body RI moves along the first guide rail GR1) to achieve the state DO where the opening/closing body D is opened. Each wire 37 may be a belt.

In the forklift 1 in FIGS. 20 to 23 which is a reach forklift, when load handling is performed by the load handling device E1, the opening/closing body D is opened and closed using the front-back movement of the outer masts 5 instead of the lifting/lowering motion of the lifting/lowering members H as described above. Thus, in the forklift 1, it is not necessary, unlike the case for the counterbalanced forklift, to specify the height of the fork 2, which is the lifting/lowering member H, in order to open and close the opening/closing body D. Therefore, the configuration of the motion conversion mechanism A is simplified and highly versatile operation is possible.

In the fourth modification, the opening/closing body D is not limited to the door 7, and may be the sheet body N as in the first modification shown in FIGS. 11 and 12. In this case as well, for example, as the outer masts 5 move in the forward direction F, the sheet body N is pulled by a wire or belt included in the motion conversion mechanism A, to achieve the state DO where the sheet body N is opened.

### Main Effects

The forklift according to the embodiment of the present invention described above mainly achieves the following effects.
(1) The top cover body C1 that covers the upper side of the load Q placed on the fork 2 and the side cover body C2 that covers the lateral side of the load Q are provided, thereby protecting the load Q from wind and rain during rainy weather or the like.
(2) The opening/closing body D that opens and closes the opening O of the side cover body C2 is opened by the motion conversion mechanism A, thereby eliminating the necessity of the work of attaching and removing a cover by an operator.
(3) The motion conversion mechanism A does not include a drive mechanism including a motor, and opens the opening/closing body D using the motion of the load handling device E1, thereby eliminating the consumption of the power of the battery of the forklift 1 by a motor, and eliminating the necessity of wiring, to a motor, for supplying power, etc.

The above-described embodiment is in all aspects illustrative and not restrictive. Various modifications and variations can be devised without departing from the scope of the invention.

What is claimed is:

1. A forklift comprising:
a main body;
a load handling device that performs load handling;
a movement device that performs traveling operation and turning operation;
a top cover body that covers an upper side of a load placed on a fork included in the load handling device;
a side cover body that has an opening in a surface thereof in a direction from a proximal end portion toward a distal end portion of the fork, and covers a lateral side of the load;
an opening/closing body that opens and closes the opening; and
a motion conversion mechanism that opens the opening/closing body, wherein
the motion conversion mechanism opens the opening/closing body using one of:
a lifting/lowering motion of a lifting/lowering member included in the load handling device;
a tilting motion, of an outer mast supporting the lifting/lowering member, by a tilt cylinder included in the load handling device; and
front-back movement of the outer mast included in the load handling device.

2. The forklift according to claim 1, wherein the motion conversion mechanism opens the opening/closing body using the lifting/lowering motion of the lifting/lowering member,
the opening/closing body is opened and closed in a middle range of a stroke of the lifting/lowering motion, and
a state where the opening/closing body is closed or a state where the opening/closing body is opened is maintained at a position above the middle range and at a position below the middle range.

3. The forklift according to claim 1, wherein
the motion conversion mechanism opens the opening/closing body using the lifting/lowering motion of the lifting/lowering member,
the opening/closing body is in a closed state at a predetermined height position in a middle of a stroke of the lifting/lowering motion,
the opening/closing body is opened as the lifting/lowering member is moved downward from the predetermined height position, and a state where the opening/closing body is opened is maintained when the lifting/lowering member is further moved downward, and
the opening/closing body is opened as the lifting/lowering member is moved upward from the predetermined height position, and a state where the opening/closing body is opened is maintained when the lifting/lowering member is further moved upward.

4. The forklift according to claim 1, wherein
the motion conversion mechanism opens the opening/closing body using the front-back movement of the outer mast, and
as the outer mast moves in a forward direction, the opening/closing body is pulled by a wire or a belt to open the opening/closing body.

5. The forklift according to claim 1, wherein the motion conversion mechanism includes a mechanism that increases displacement of a stroke of the lifting/lowering motion or a mechanism that increases displacement of a stroke of the tilting motion.

6. The forklift according to claim 1, further comprising a biasing unit that biases the opening/closing body in a direction in which the opening/closing body is closed.

7. The forklift according to claim 1, wherein
the motion conversion mechanism opens the opening/closing body using the lifting/lowering motion of the lifting/lowering member,
the opening/closing body is a door,
the door is provided with at an upper portion thereof a door runner,
the door runner moves along a guide rail,
the motion conversion mechanism includes a link mechanism that transmits an operation force by the lifting/lowering motion to the door, and
the door is rotated around a vertical axis by the operation force while the door runner is moving along the guide rail.

8. The forklift according to claim 7, wherein
the door is of a double swing type including left and right door bodies,
the door runner includes
an inner runner body located at an inner end in a right-left direction of each of the door bodies and rotatable around a vertical axis relative to the door body, and
an outer runner body located at an outer end in the right-left direction of each of the door bodies and rotatable around a vertical axis relative to the door body,
the inner runner body moves along a first guide rail in the right-left direction,
the outer runner body moves along a second guide rail in a front-back direction,
the link mechanism includes
guide bodies attached to the lifting/lowering member,
operation arms that is driven by lifting and lowering of the guide bodies, and slide arms that moves along the second guide rails by the operation arms,
each of the operation arms rotates around a support axis in the right-left direction,
each of the operation arms has a first end portion that moves along the guide body,
each of the operation arms has a second end portion that is connected to a runner body that is a first end portion of the slide arm,
each of the slide arms has a second end portion that is the outer runner body, and
as the lifting/lowering member is lifted or lowered, the first end portion of the operation arm moves along the guide body, whereby the operation arm rotates around the support axis, and the second end portion of the operation arm moves the slide arm in a backward direction along the second guide rail, thereby opening the door body.

9. The forklift according to claim 8, wherein
a center of gravity of the operation arm is located in a forward direction with respect to the support axis, and
a moment that tilts the operation arm forward around the support axis is applied by a dead weight of the operation arm.

10. The forklift according to claim 8, wherein a distance from the support axis to the second end portion of the operation arm is larger than a distance from the support axis to the first end portion of the operation arm.

11. The forklift according to claim 8, wherein
each of the guide bodies includes an inclined portion which is inclined forward and upward,
the first end portion of each of the operation arms moves along the inclined portion,
the operation arm includes a lower arm portion extending in a forward direction from the first end portion and an upper arm portion extending upward from a front end of the lower arm portion in a state where the door bodies are closed, and
as the lifting/lowering member is lowered, the first end portion of the operation arm moves along the inclined portion of the guide body, whereby the operation arm rotates around the support axis, and the second end portion of the operation arm and the slide arm move in the backward direction, thereby opening the door body.

12. The forklift according to claim 11, wherein
each of the guide bodies includes a vertical portion extending vertically upward from an upper end of the inclined portion, and
in a state where the first end portion of the operation arm is moving along the vertical portion, the operation arm does not rotate around the support axis.

13. The forklift according to claim 1, wherein the motion conversion mechanism is a winding transmission device.

14. The forklift according to claim 13, wherein the winding transmission device includes a wire pulled by a lowering motion of the lifting/lowering member and a pulley on which the wire is trained.
